(19) United States
(12) Patent Application Publication
(10) Pub. No.: US 2010/0097322 A1
(43) Pub. Date: Apr. 22, 2010

(54) APPARATUS AND METHOD FOR SWITCHING TOUCH SCREEN OPERATION

(75) Inventors: Yong-Hua Hu, Nanjing (CN); Jiang Jun, Nanjing (CN)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 12/252,791

(22) Filed: Oct. 16, 2008

(51) Int. Cl. G06F 3/041

(52) U.S. Cl. 345/173

(57) ABSTRACT

An apparatus (100) and method for switching touch screen operation. The apparatus can include a hand held electronic device housing (110). The hand held electronic device housing can have a housing face (112) and a housing side (114) substantially orthogonal to the housing face. The apparatus can include a touch screen display (120) located on the housing face. The touch screen display can be configured to display information and can be configured to receive user actuation. The apparatus can include a side user actuatable switch (130) located on the housing side. The side user actuatable switch can be configured to switch an input function of the touch screen display from a first touch screen input function having a first set of functions corresponding to a first set of inputs to a second touch screen input function having a second set of functions corresponding to a second set of inputs, where the first set of functions is different than the second set of functions.

### BACKGROUND

1. Field

The present disclosure is directed to an apparatus and method for controlling touch screen operation. More particularly, the present disclosure is directed to switching between a first touch screen input function and a second touch screen input function.

2. Introduction

Presently, electronic devices can use touch screen displays for various input functions. Touch screen displays both display information and receive user input on the same display. While touch screen displays can be used on larger devices, such as desktop and laptop computers, they can also be used on hand held electronic devices that can be carried in a user's pocket and held in a user's hand. When using a touch screen display, a user can enter data, can move and manipulate icons and images, can scroll and zoom windows and images, and can perform other input functions using the touch screen display. Unfortunately, a user can only use certain touch screen display functions, such as move, zoom, and rotation functions, within certain applications by using relevant menus, by using dedicated touch screen buttons, or by using multiple finger motions. For example, when a user must use a relevant menu in a specific application for a desired function, it may be inconvenient to access the specific menu, the desired function may not be available in all applications, and it may be difficult for the user to accurately activate small menu buttons on a small touch screen display.

Furthermore, some devices, such as an iphone™, can allow a user to activate different functions by using multiple fingers at the same time on a touch screen display. Unfortunately, to activate different functions using multiple fingers, a user must hold the device in one hand while using multiple fingers on another hand to activate the function. Thus, a user cannot use one hand to conveniently switch between different input functions on such a device because the user must use two hands to activate different multiple finger functions.

Thus, there is a need for an apparatus and method for switching touch screen operation.

### SUMMARY

An apparatus and method for switching touch screen operation. The apparatus can include a hand held electronic device housing. The hand held electronic device housing can have a housing face and a housing side substantially orthogonal to the housing face. The apparatus can include a touch screen display located on the housing face. The touch screen display can be configured to display information and can be configured to receive user actuation. The apparatus can include a side user actuatable switch located on the housing side. The side user actuatable switch can be configured to switch an input function of the touch screen display from a first touch screen input function having a first set of functions corresponding to a first set of inputs to a second touch screen input function having a second set of functions corresponding to a second set of inputs, where the first set of functions is different than the second set of functions.

### BRIEF DESCRIPTION OF THE DRAWINGS

In order to describe the manner in which advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary illustration of an apparatus according to a possible embodiment;

FIG. 2 is an exemplary illustration of the apparatus according to a possible embodiment;

FIG. 3 is an exemplary illustration of gestures according to a possible embodiment;

FIG. 4 is an exemplary illustration of operations on a touch screen display according to a possible embodiment;

FIG. 5 is an exemplary illustration of operations on a touch screen display according to a possible embodiment;

FIG. 6 is an exemplary illustration of operations on a touch screen display according to a possible embodiment;

FIG. 7 is an exemplary illustration of operations on a touch screen display according to a possible embodiment;

FIG. 8 is an exemplary illustration of operations on a touch screen display according to a possible embodiment;

FIG. 9 is an exemplary illustration of operations on a touch screen display according to a possible embodiment;

FIG. 10 is an exemplary block diagram of a wireless communication device according to a possible embodiment; and

FIG. 11 is an exemplary flowchart illustrating the operation of an apparatus according to a possible embodiment.

### DETAILED DESCRIPTION

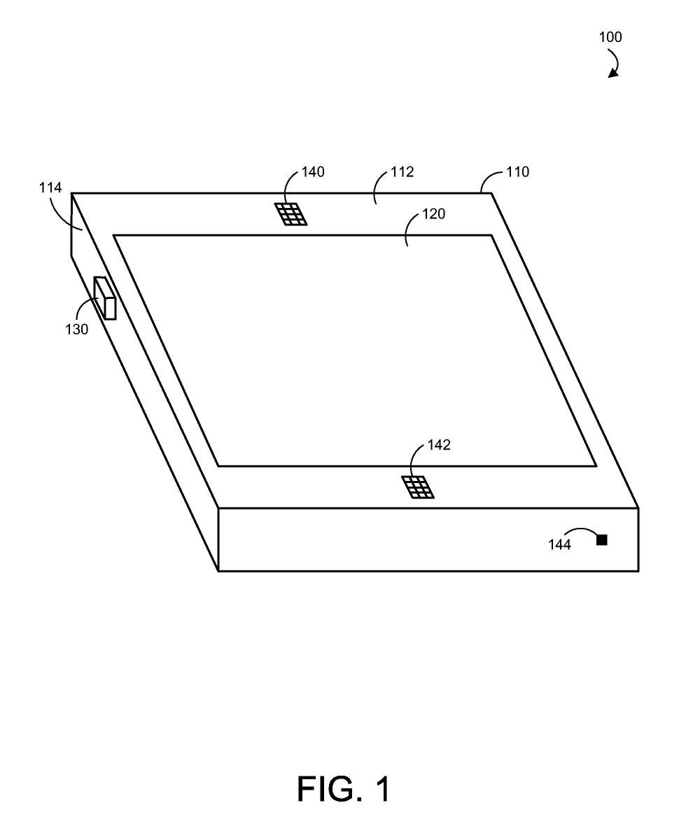

FIG. 1 is an exemplary illustration of an apparatus 100 according to a possible embodiment. The apparatus 100 can be a hand held electronic device, such as a mobile phone, a Personal Digital Assistant (PDA), a smart phone, a multimedia player, a MP3 player, a digital broadcast receiver, or any other apparatus that can include a touch screen display and can be held in a hand of a user. The apparatus 100 can include a hand held electronic device housing 110. The hand held electronic device housing 110 can have a housing face 112 and a housing side 114 substantially orthogonal to the housing face 112. The apparatus 100 can include a touch screen display 120 located on the housing face 112. The touch screen display 120 can be configured to display information and can be configured to receive user actuation. The touch screen display 120 can have a width of between about 20 mm to about 90 mm and a length of between about 20 mm to about 90 mm. The touch screen display 120 can be a capacitive sensor touch screen display. The touch screen display 120 can also be a resistive touch screen, an inductive touch screen, a surface acoustic wave touch screen, an infrared touch screen, a strain gauge touch screen, an optical imaging touch screen, a dispersive signal technology touch screen, or any other touch screen that can be used on a hand held electronic device.

The apparatus 100 can include a side user actuatable switch 130 located on the housing side 114. The side user actuatable switch 130 can be configured to switch an input function of the touch screen display 120 from a first touch screen input function having a first set of functions corresponding to a first set of inputs to a second touch screen input function having a second set of functions corresponding to a second set of inputs, where the first set of functions is different than the second set of functions. The sets of functions refer to a unique grouping of functions. For example, between sets, some of the functions may be the same. However, the overall set of functions in the first set of functions will include at least one different function from the overall set of functions in the second set of functions. The first set of inputs may be the same as the second set of inputs and the side user actuatable switch can switch functions associated with one, some, or all of the inputs. The first set of inputs may alternately include some different inputs from the second set of inputs.

Input functions can be functions for a picture viewer application, for a view finder application, for a web browser application, for a map application, for a media player application, for a phonebook application, for combinations of applications, or for any other applications. The input functions can be functions based on tap inputs on the touch screen display 120, based on gesture inputs on the touch screen display 120, based on combinations of inputs on the touch screen display 120, or based on other inputs on the touch screen display 120. For example a tap input can be a temporary press on the touch screen display 120 and a gesture can be a sliding input or multiple sliding inputs on the touch screen display. The gestures can be substantially linear gestures along a horizontal or vertical axis on the touch screen display 120, can be gestures at an angle to a horizontal or vertical axis on the touch screen display 120, can be arced gestures, or can be a combination of horizontal, vertical, angled, and/or arced gestures. For example, a combination of gestures can be made by pressing on the touch screen display 120 and chaining multiple gestures together as long as the touch screen display 120 is pressed. According to one embodiment, the apparatus 100 can wait until the completion of a gesture before operating based on the gesture. According to another embodiment, the apparatus 100 can operate based on a gesture as the gesture is being input. For example, the touch screen display 120 can move an object or scroll images on the touch screen display 120 based on a gesture while the gesture is being input. Alternately, the touch screen display 120 can await completion of the gesture before moving, scrolling, rotating or otherwise acting on the gesture.

The side user actuatable switch 130 can be configured to switch an input function of the touch screen display 120 from a first touch screen input function while the side user actuatable switch 130 is not actuated to a second touch screen input function while the side user actuatable switch 130 is actuated. For example, the second touch screen input function can be activated as long as the side user actuatable switch 130 is held by a user and the first touch screen input function can be activated as long as the side user actuatable switch 130 is released or not held. Thus, the side user actuatable switch 130 can determine which touch screen input function is activated depending on whether the side user actuatable switch 130 is held or released. Alternately, the side user actuatable switch 130 can switch touch screen input functions each time the side user actuatable switch 130 is either engaged or engaged and released. As a further example, a first touch screen input function can be a default input function and a second touch screen input function can be enabled as long as the side user actuatable switch is engaged.

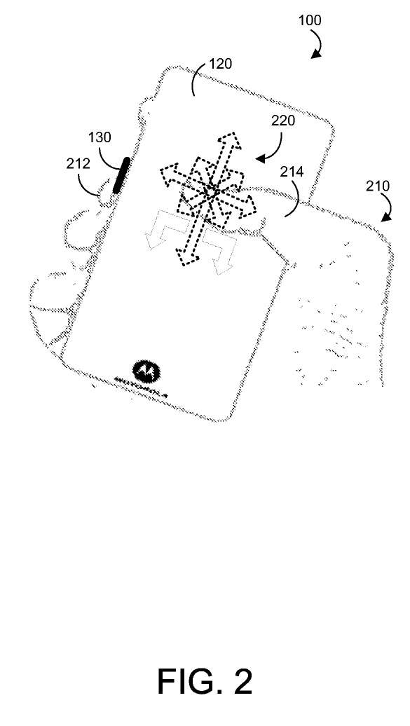

FIG. 2 is an exemplary illustration of the apparatus 100 according to a possible embodiment. The touch screen display 120 can be configured to receive user actuation by detecting a location on the touch screen display touched by a digit 214 of a hand 210 of a user. The side user actuatable switch 130 can be configured to switch a single digit input function of the touch screen display 120 from a first touch screen input function while the side user actuatable switch 130 is not pressed to a second touch screen input function while the side user actuatable switch 130 is pressed. The input functions can correspond to taps, presses, gestures 220, or other inputs on the touch screen display 120. The side user actuatable switch 130 can be configured to be activated by a finger 212 of a hand 210 of a user and the touch screen display 120 can be configured to be activated by a thumb 214 of the same hand 210 of the user while the side user actuatable switch 130 is activated by the finger 212 of the user. The touch screen display 120 can also receive user actuation from a pointing device, a stylus, or any other device that can provide actuation on a touch screen display.

The side user actuatable switch 130 can be a side button located 130 on the housing side. The side button 130 can be configured to receive input from a digit 212 of a hand 210 of a user. The side button 130 can also be configured to switch an input function of the touch screen display 120 from a first touch screen input function while the side button 130 is not pressed to a second touch screen input function while the side button 130 is pressed. The side user actuatable switch 130 can also be a touch sensitive strip, a slidable switch, a touch sensor, or any other user actuatable switch.

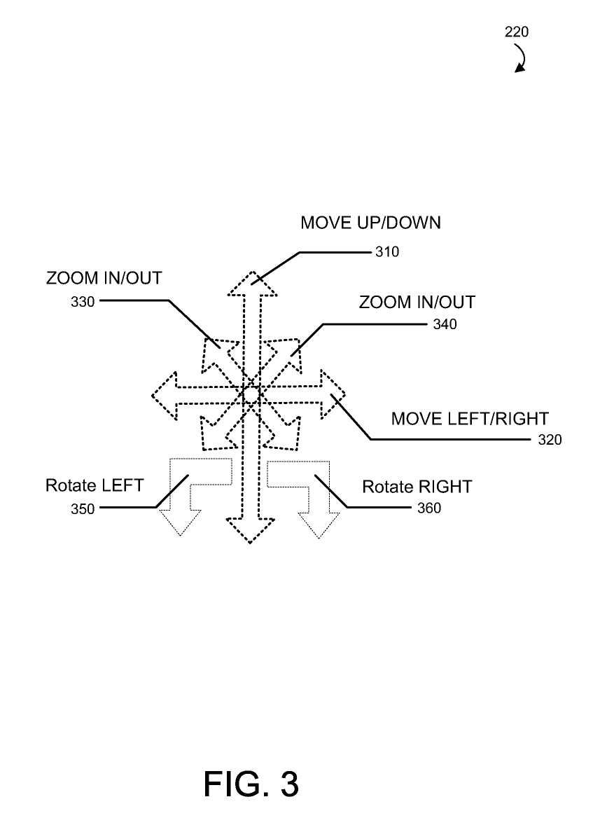

FIG. 3 is an exemplary illustration of gestures 220 according to a possible embodiment. The gestures can include substantially vertical gestures 310, substantially horizontal gestures 320, substantially angled gestures 330 and 340, arced or combinations of gestures 350 and 360, and other gestures. For example, vertical gestures 310 can move objects up and down on the touch screen display 120, horizontal gestures 320 can move objects left and right on the touch screen display 120, angled gestures 330 and 340 can zoom in and out on objects on the touch screen display 120, and arced or combinations of gestures 350 and 360 can rotate objects on the touch screen display 120. Gestures 220, presses, taps, and other inputs can correspond to input functions of the touch screen display 120.

The side user actuatable switch 130 can be configured to switch between at least two of a move input function of the touch screen display 120, a rotate input function of the touch screen display 120, a data input function of the touch screen display 120, a cursor control input function of the touch screen display 120, a mouse control input function of the touch screen display 120, a selection input function of the touch screen display 120, a drag input function of the touch screen display 120, a control input function of the touch screen display 120, a media player control input function of the touch screen display 120, a phone book entry search input function of the touch screen display 120, a handwriting recognition input function of the touch screen display 120, a zoom input function of the touch screen display 120, or other input functions of the touch screen display 120.

To elaborate further on examples of switchable touch screen input functions, a sliding gesture input on the touch screen display 120 can move an image on the touch screen display 120 in a corresponding direction of the sliding gesture. Also, a sliding gesture in one direction can zoom in on an image and a sliding gesture in an opposite direction can zoom out from an image. Additionally, tapping on a virtual keypad on the touch screen display 120 can provide for data input on the touch screen display 120. Furthermore, tapping the touch screen display 120 can place a cursor or a mouse at the tapped location of the touch screen display 120 and sliding along the touch screen display 120 can move the cursor or mouse on the touch screen display 120. Also, pressing or double pressing on a location of the touch screen display 120 can select an object on the touch screen display 120 and sliding on the touch screen display 120 can move the object on the touch screen display 120. Additionally, properties of the touch screen display 120, such as brightness, contrast, the size of objects, and other properties can be controlled using inputs on the touch screen display 120. Furthermore, sliding gestures 220 on the touch screen display 120 can rotate images or objects on the touch screen display 120. Also, other inputs on the touch screen display 120 can control other operations on the touch screen display 120. The side user actuatable switch 130 can be used to switch between these and other different input functions.

As a further example, the apparatus 100 can have a camera function and the touch screen display 120 can act as a viewfinder. The side user actuatable switch 130 can activate a second touch screen input function to allow a user to move, zoom in, zoom out, rotate, and otherwise manipulate an image to be captured in the viewfinder. Thus, a user can preview different views of the image before capturing the image. Different digits can be used on a user's single hand 210 when using the camera function or two hands can be used when using the camera function. The manipulated preview image can be maintained when the side user actuatable switch 130 is released or the preview image can revert to the original image when the side user actuatable switch 130 is released. A soft key on the touch screen display 120, an alternate key on the hand held electronic device housing 110, or the side user actuatable switch 130 can then be used to capture the image. As one example, the user can briefly actuate and release the side user actuatable switch 130 to capture the image without activating the second touch screen input function. The image can be captured while the manipulated image is on the touch screen display 120 or when the original image is returned to the touch screen display 120.

As another example, the apparatus 100 can have an Internet browser application. The side user actuatable switch 130 can activate a second touch screen input function to allow a user to move, zoom in, zoom out, rotate, and otherwise manipulate a data, images, and other aspects of a web site in a browser window on the touch screen display 120. As another example, the hand held electronic device can have a map application. The side user actuatable switch 130 can activate a second touch screen input function to allow a user to move, zoom in, zoom out, rotate, and otherwise manipulate a map or related images and data on the touch screen display 120.

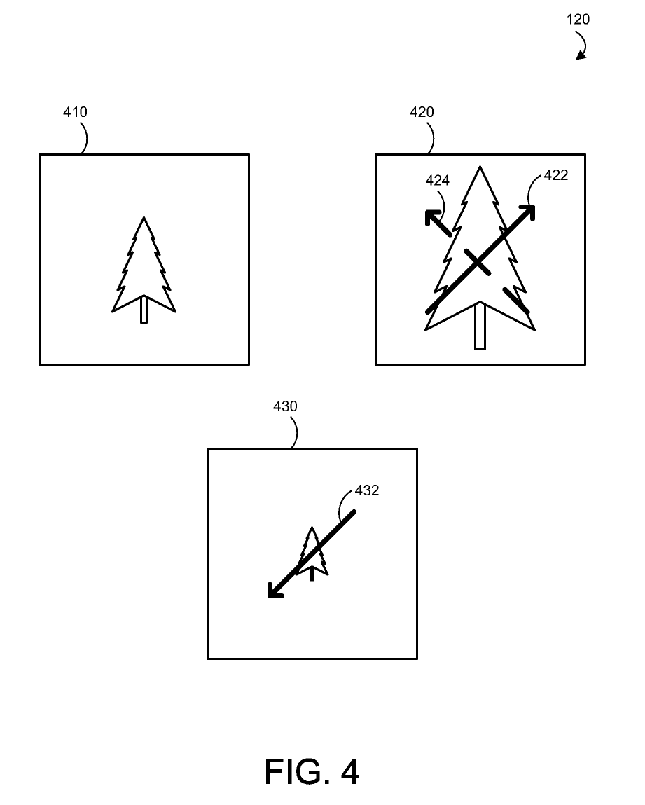

FIG. 4 is an exemplary illustration of operations on the touch screen display 120 according to a possible embodiment. The touch screen display 120 can be configured to display an original image 410 and the second touch screen input function can manipulate the original image 410 to display a manipulated image 420 or 430 as long as the side user actuatable switch is activated 130. The manipulated image 420 or 430 can return to the original image 410 when the side user actuatable switch 130 is deactivated. For example, the second touch screen input function can move, rotate, zoom, or otherwise manipulate an image long as the side user actuatable switch 130 is activated and the image can return to an unmoved, unrotated, unzoomed, and/or otherwise unmanipulated image when the side user actuatable switch 130 is deactivated. Alternately, the image can remain manipulated after the side user actuatable 130 switch is deactivated. According to the example illustration, an angled gesture 422 or 424 can be used to zoom in on an image 410 to display a larger image 420 and another angled gesture 432 can be used to zoom out from an image 410 to display a smaller image 430. Other gestures may be used for any input functions described in all of the embodiments. For example, a horizontal, vertical, circular, or other gesture instead of an angled gesture may be used to zoom in and out.

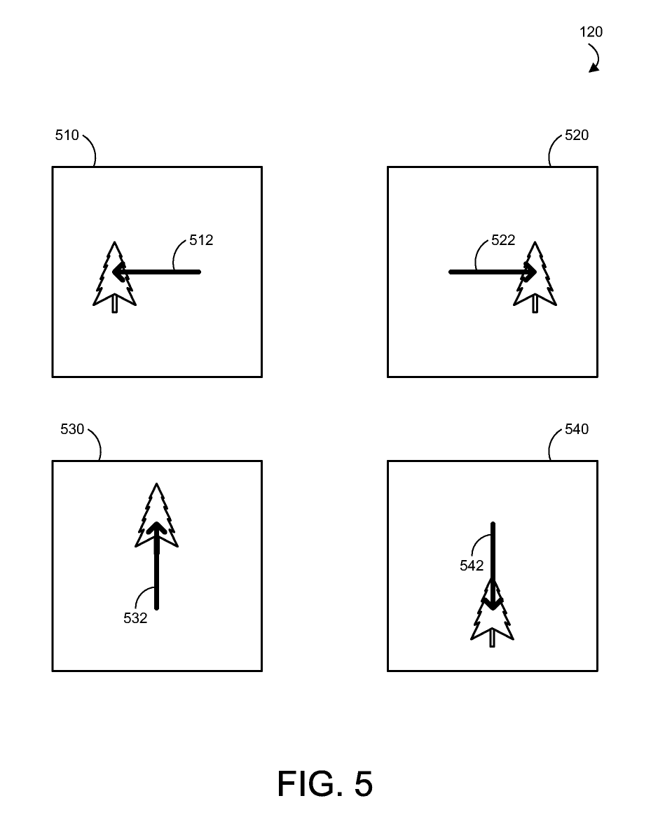

FIG. 5 is an exemplary illustration of operations on the touch screen display 120 according to a possible embodiment. According to the example illustration, a left sliding gesture 512 can move an image to the left 510, a right sliding gesture 522 can move an image to the right 520, a upwards sliding gesture 532 can move an image up 530, and a downwards sliding gesture 542 can move an image down 540 on the touch screen display 120. Other gestures can also be used to move the image.

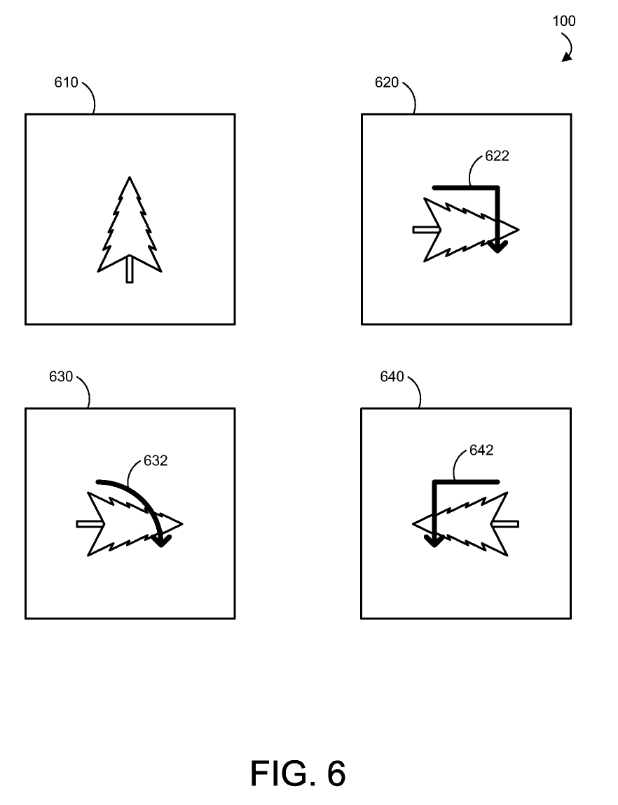

FIG. 6 is an exemplary illustration of operations on the touch screen display 120 according to a possible embodiment. According to the example illustration, a combination gesture 622 of a vertical gesture and a horizontal gesture in one direction can rotate an image from an original image 610 to a rotated image 620 in the direction of the combination gesture 622. A combination gesture 642 of a vertical gesture and a horizontal gesture in another direction can rotate the image to a rotated image 640 in the direction of the combination gesture 642. Other gestures can be used for input functions. For example, an arced gesture 632 can rotate the image to a rotated image 630 in the direction of the arced gesture 632.

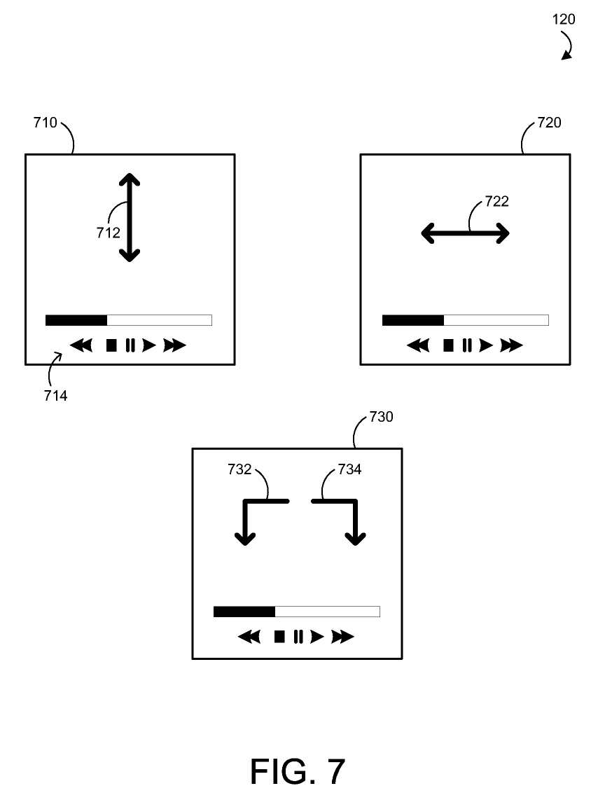

FIG. 7 is an exemplary illustration of operations on the touch screen display 120 according to a possible embodiment. According to this example, the apparatus 100 can have a media player application. The side user actuatable switch 130 can activate a second touch screen input function to allow a user increase and decrease volume 710 by using one gesture 712, fast forward and rewind media playback 720 using another gesture 722, jump between previous and next media files 730 using other gestures 732 and 734, switch between playback options using other gestures, and otherwise control the media player application using other inputs and gestures. Icons 714, such as soft keys, on the touch screen display 120 can also be used when the side user actuatable switch 130 is activated or deactivated to control the media player. The side user actuatable switch 130 can be used to allow for gestures as an alternate convenient method to control the media player while the icons 714 are displayed or hidden.

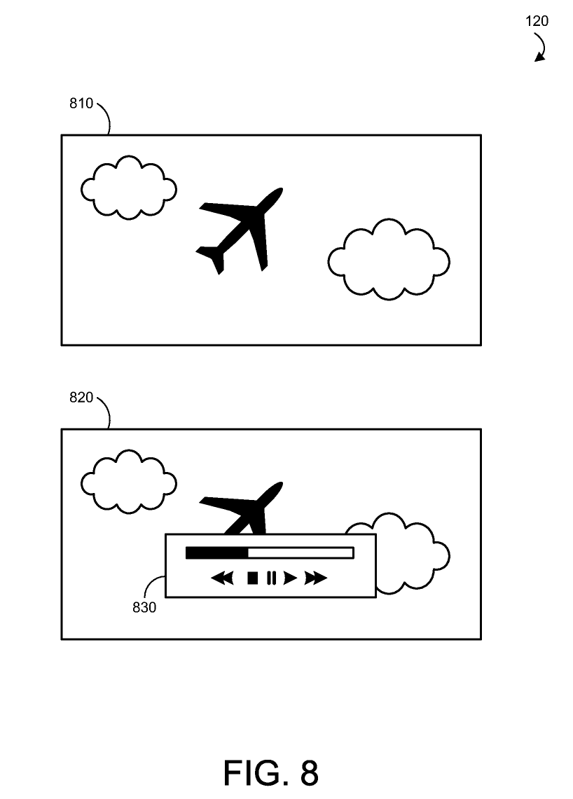

FIG. 8 is an exemplary illustration of operations on the touch screen display 120 according to a possible embodiment. According to this example, the side user actuatable 130 switch can allow for media player control using gestures when icons are eliminated or hidden in a full screen viewing mode 810. For example, the side user actuatable switch 130 can be used to provide a pop up panel 830 that can be a window that overlays other elements in a pop up panel viewing mode 820 on the touch screen display 120. The pop up panel 830 can include icons, such as soft buttons, for control of the media player when the media player is in a full screen mode.

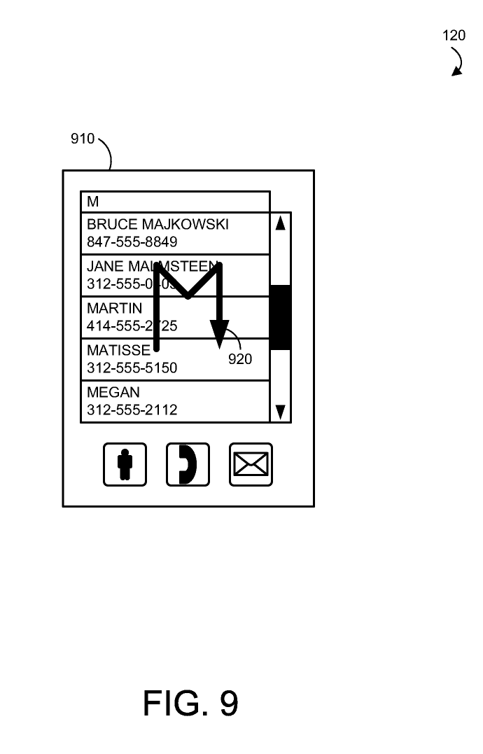

FIG. 9 is an exemplary illustration of operations on the touch screen display 120 according to a possible embodiment. According to this example, the second touch screen input function can be a gesture search input function that provides for searching data on the apparatus 100 based on a gesture 920 on the touch screen display 120. For example, the touch screen display 120 can display part of a list of entries 910 and a user can use a gesture 920 to direct the apparatus 100 to jump to an entry or a group of entries corresponding to the gesture 920. The second touch screen input function can also be a handwriting recognition input function that provides for data entry using handwriting recognition on the touch screen display 120. The handwriting recognition function can be used for data entry for entering text in some applications and can provide for searching for entries in a phonebook application based on a character 920 entered using handwriting recognition. For example, apparatus 100 can have a phonebook application. The side user actuatable switch 130 can activate a second touch screen input function to allow a user to use gestures to highlight, search through, scroll through, or browse though phonebook entries. These and/or other input functions can also be default input functions corresponding to the first touch screen input function. The side user actuatable switch can 130 also switch between different touch screen input functions. For example, the side user actuatable switch 130 can activate a second touch screen input function to allow a user to use gestures to activate functions relating to phonebook entries, or otherwise interact with the phonebook application. For handwriting recognition, a user can use gestures to draw one or more letters or characters 920 on the touch screen display 120 to jump to entries starting with or relating to the drawn letters or characters 920. Actuation or deactuation of the side user actuatable switch 130 can switch between various input functions for the phonebook application.

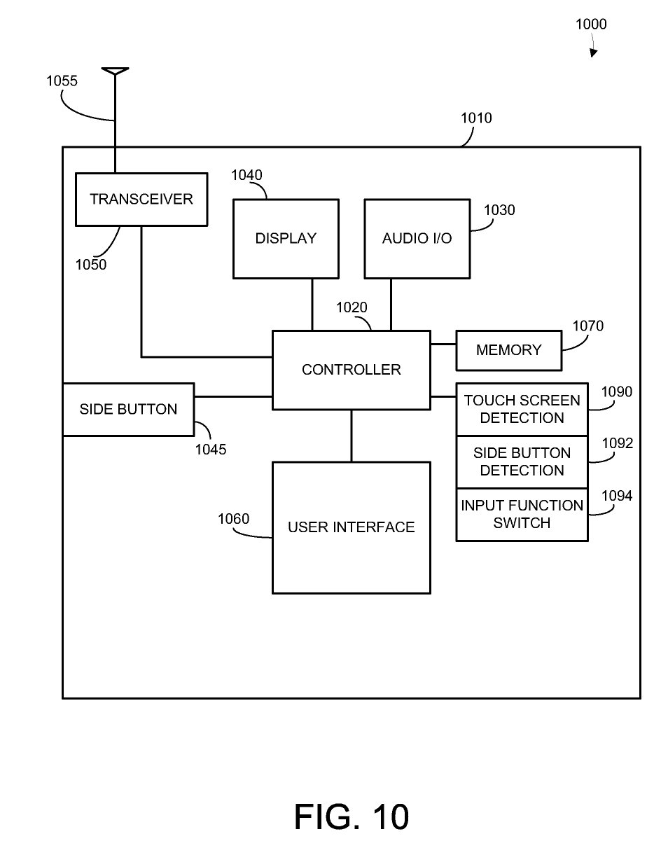

FIG. 10 is an exemplary block diagram of a wireless communication device 1000, such as the apparatus 100, according to a possible embodiment. The wireless communication device 1000 can include a hand held electronic device housing 1010, a controller 1020 coupled to the hand held electronic device housing 1010, audio input and output circuitry 1030 coupled to the hand held electronic device housing 1010, a touch screen display 1040 coupled to the hand held electronic device housing 1010, a side button 1045 coupled to the hand held electronic device housing 1010, a transceiver 1050 coupled to the hand held electronic device housing 1010, an antenna 1055 coupled to the transceiver 1050, a user interface 1060 coupled to the hand held electronic device housing 1010, and a memory 1070 coupled to the hand held electronic device housing 1010. The wireless communication device 1000 can also include a touch screen detection module 1090, a side button detection module 1092, and an input function switch module 1094. The touch screen detection module 1090, the side button detection module 1092, and the input function switch module 1094 can be coupled to the controller 1020, can reside within the controller 1020, can reside within the memory 1070, can be autonomous modules, can be software, can be hardware, or can be in any other format useful for a module on a wireless communication device.

The transceiver 1050 may include a transmitter and/or a receiver. The audio input and output circuitry 1030 can include a microphone, a speaker, a transducer, or any other audio input and output circuitry. The user interface 1060 can include a keypad, buttons, a touch pad, a joystick, an additional display, or any other device useful for providing an interface between a user and an electronic device. The memory 1070 may include a random access memory, a read only memory, an optical memory, a subscriber identity module memory, or any other memory that can be coupled to a wireless communication device.

Similar to apparatus 100, the hand held electronic device housing 1010 can have a housing face and a housing side substantially orthogonal to the housing face. The touch screen display 1040 can be located on the housing face. The touch screen display 1040 can be configured to display information and can be configured to receive input from at least a digit of a hand of a user. The side button 1045 can be located on the housing side and the side button 1045 can be configured to receive input from at least a digit of a hand of a user. The side button 1045 can be configured to be activated by a finger of a hand of a user. The touch screen display 1040 can be configured to be activated by a thumb of the same hand of the user while the side button 1045 is activated by the finger of the user.

The controller 1020 can be configured to control operations of the wireless communication device 1000. The touch screen detection module 1090 can be configured to detect a location on the touch screen display 1040 touched by a digit of a hand of a user. The side button detection module 1092 can be configured to detect actuation of the side button 1045 by a digit of a hand of a user. The input function switch module 1094 can be configured to switch an input function of the touch screen display 1040 from a first touch screen input function while the side button 1045 is not actuated to a second touch screen input function while the side button 1045 is actuated. The touch screen display 1040 can be configured to display an original image and the second touch screen input function can manipulate the original image to display a manipulated image on the touch screen display 1040. The second touch screen input function can also be a handwriting recognition input function that provides for data entry using handwriting recognition on the touch screen display 1040. The handwriting recognition input function can also provide for searching for entries in a phonebook application based on a character entered using handwriting recognition.

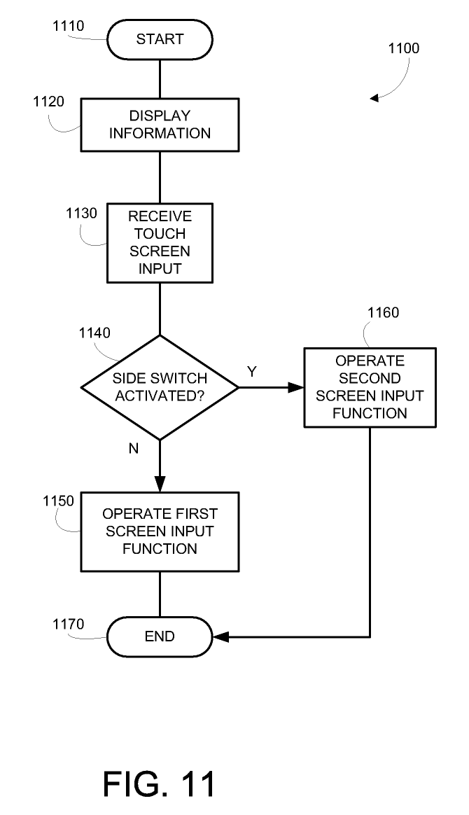

FIG. 11 is an exemplary flowchart 1100 illustrating the operation of the apparatus 100 according to a possible embodiment. At 1110, the flowchart begins. At 1120, information is displayed on a touch screen display. At 1130, input is received on the touch screen display. At 1140, a determination is made as to whether the side user actuatable switch is actuated. If the side user actuatable switch is not actuated, at 1150, a first touch screen input function is operated based on the input on the touch screen display. If the side user actuatable switch is actuated, at 1160, a second touch screen input function is operated based on the input on the touch screen display. The first touch screen input function can be a data entry input function or any other input function and the second touch screen input function can be an image manipulation function or any other input function. For example, the data entry input function can provide for user entry on a virtual keyboard or on icons on the touch screen display and the image manipulation function can provide for zooming, moving, rotating, and otherwise manipulating an image on a touch screen display. In step 1170, the flowchart 1100 ends.

Embodiments can provide for a single hand shortcut touch method for touch screen display control. According to some embodiments, a user can experience a more convenient shortcut touch method to control the touch screen display. A push button can be added at the side of a touch input device. When a user presses and holds the push button at any time, the user can use a thumb motion for display control. Embodiments can provide for a single hand shortcut touch method for touch screen display control that allows a user to control the touch screen display in any screen scene. Embodiments can reduce the need to activate small menus or touch screen buttons accurately. Furthermore, unlike a multiple finger motion control method, only one hand can be enough to control desired functions on the touch screen display.

The methods of this disclosure are preferably implemented on a programmed processor. However, the operations of the embodiments may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the operations of the embodiments may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. Also, relational terms, such as “top,” “bottom,” “front,” “back,” “horizontal,” “vertical,” and the like may be used solely to distinguish a spatial orientation of elements relative to each other and without necessarily implying a spatial orientation relative to any other physical coordinate system. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. An apparatus comprising:
a hand held electronic device housing, the hand held electronic device housing having a housing face and a housing side substantially orthogonal to the housing face;
a touch screen display located on the housing face, the touch screen display configured to display information and configured to receive user actuation; and
a side user actuatable switch located on the housing side, the side user actuatable switch configured to switch an input function of the touch screen display from a first touch screen input function having a first set of functions corresponding to a first set of inputs to a second touch screen input function having a second set of functions corresponding to a second set of inputs, where the first set of functions is different than the second set of functions.

2. The apparatus according to claim 1, wherein the side user actuatable switch is configured to switch an input function of the touch screen display from a first touch screen input function while the side user actuatable switch is not actuated to a second touch screen input function while the side user actuatable switch is actuated.

3. The apparatus according to claim 1, wherein the touch screen display is configured to receive user actuation by detecting a location on the touch screen display touched by a digit of a hand of a user.

4. The apparatus according to claim 3, wherein the side user actuatable switch is configured to switch a single digit input function of the touch screen display from a first touch screen input function while the side user actuatable switch is not pressed to a second touch screen input function while the side user actuatable switch is pressed.

5. The apparatus according to claim 3,
wherein the side user actuatable switch is configured to be activated by a finger of a hand of a user, and
wherein the touch screen display is configured to be activated by a thumb of the same hand of the user while the side user actuatable switch is activated by the finger of the user.

6. The apparatus according to claim 1, wherein the side user actuatable switch comprises a side button located on the housing side, the side button configured to receive input from a digit of a hand of a user, and the side button configured to switch an input function of the touch screen display from a first touch screen input function while the side button is not pressed to a second touch screen input function while the side button is pressed.

7. The apparatus according to claim 1, wherein the side user actuatable switch is configured to switch between at least two of a move input function of the touch screen display, a rotate input function of the touch screen display, a data input function of the touch screen display, a cursor control input function of the touch screen display, a mouse control input function of the touch screen display, a selection input function of the touch screen display, a drag input function of the touch screen display, a control input function of the touch screen display, a media player control input function of the touch screen display, a phone book entry search input function of the touch screen display, a handwriting recognition input function of the touch screen display, and a zoom input function of the touch screen display.

8. The apparatus according to claim 1, wherein the touch screen display has a width of between about 20 mm to about 90 mm and a length of between about 20 mm to about 90 mm.

9. The apparatus according to claim 1, wherein the touch screen display comprises a capacitive sensor touch screen display.

10. The apparatus according to claim 1,
wherein the touch screen display is configured to display an original image and the second touch screen input function manipulates the original image to display a manipulated image as long as the side user actuatable switch is activated, and
wherein the manipulated image returns to the original image when the side user actuatable switch is deactivated.

11. The apparatus according to claim 1, wherein the second touch screen input function comprises a gesture search input function that provides for searching data on the apparatus based on a gesture on the touch screen display.

12. The apparatus according to claim 1, wherein the second touch screen input function comprises a handwriting recognition input function that provides for data entry using handwriting recognition on the touch screen display.

13. The apparatus according to claim 12, wherein the handwriting recognition input function provides for searching for entries in a phonebook application based on a character entered using handwriting recognition.

14. An apparatus comprising:
a hand held electronic device housing, the hand held electronic device housing having a housing face and a housing side substantially orthogonal to the housing face;
a touch screen display located on the housing face, the touch screen display configured to display information and configured to receive input from a digit of a hand of a user; and
a side button located on the housing side, the side button configured to receive input from a digit of a hand of a user;
a controller coupled to the touch screen and the side button, the controller configured to control operations of the apparatus;
a touch screen detection module coupled to the controller, the touch screen detection module configured to detect a location on the touch screen display touched by a digit of a hand of a user;
a side button detection module coupled to the controller, the side button detection module configured to detect actuation of the side button by a digit of a hand of a user; and
an input function switch module coupled to the controller, the input function switch module configured to switch an input function of the touch screen display from a first touch screen input function while the side button is not actuated to a second touch screen input function while the side button is actuated.

15. The apparatus according to claim 14,
wherein the side button is configured to be activated by a finger of a hand of a user, and
wherein the touch screen display is configured to be activated by a thumb of the same hand of the user while the side button is activated by the finger of the user.

16. The apparatus according to claim 14, wherein the touch screen display is configured to display an original image and the second touch screen input function manipulates the original image to display a manipulated image on the touch screen display.

17. The apparatus according to claim 14, wherein the second touch screen input function comprises a handwriting recognition input function that provides for data entry using handwriting recognition on the touch screen display.

18. The apparatus according to claim 17, wherein the handwriting recognition input function provides for searching for entries in a phonebook application based on a character entered using handwriting recognition.

19. A method in a hand held electronic device including a hand held electronic device housing, the hand held electronic device housing having a housing face and a housing side substantially orthogonal to the housing face, a touch screen display located on the housing face, and a side user actuatable switch located on the housing side, the method comprising:
displaying information on the touch screen display;
receiving input on the touch screen display;
determining whether the side user actuatable switch is actuated;
operating a first touch screen input function based on the input on the touch screen display if the side user actuatable switch is not actuated; and
operating a second touch screen input function based on the input on the touch screen display if the side user actuatable switch is actuated.

20. The method according to claim 19, wherein the first touch screen input function comprises a data entry input function and the second touch screen input function comprises an image manipulation function.
